(19) United States
(12) Patent Application Publication
(10) Pub. No.: US 2010/0158036 A1
(43) Pub. Date: Jun. 24, 2010

(54) METHOD AND APPARATUS OF RECEIVING BURST DATA USING MULTIPLE UPSTREAM CHANNELS BASED ON UPSTREAM BANDWIDTH ALLOCATION INFORMATION IN HFC NETWORK

(75) Inventors: Dong Joon CHOI, Daejeon (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon (KR)

(21) Appl. No.: 12/627,153

(22) Filed: Nov. 30, 2009

(30) Foreign Application Priority Data
Dec. 22, 2008 (KR) 10-2008-0130862

(51) Int. Cl. H04B 7/212

(52) U.S. Cl. 370/442

(57) ABSTRACT

Provided is a method and apparatus for effectively receiving channel bonded upstream burst data in a Hybrid Fiber Cable (HFC) network.

### CROSS-REFERENCE TO RELATED APPLICATION

This application claims the benefit of Korean Patent Application No. 10-2008-0130862, filed on Dec. 22, 2008, in the Korean Intellectual Property Office, the disclosure of which is incorporated herein by reference.

### BACKGROUND

1. Field of the Invention

The present invention relates to a technology of receiving upstream burst data in a Hybrid Fiber Coax (HFC) network, and more particularly, to a technology that may sort segment-typed burst data, transmitted from a cable modem, according to an original order, and restore the burst data to a form of Data-over-Cable Interface Specification (DOCSIS) Media Access Control (MAC) data, and thereby may effectively receive the burst data in a Cable Modem Termination System (CMTS).

2. Description of the Related Art

A Data-over-Cable Interface Specification (DOCSIS) standard that is a data transmission protocol in a Hybrid Fiber Coax (HFC) network may perform a downstream transmission using a Time Division Multiplexing (TDM) scheme, and may perform an upstream transmission using a Time Division Multiple Access (TDMA) scheme. Specifically, the DOCSIS protocol has a structure of controlling each cable modem based on a time slot and thus a Quality of Service (QoS) may be applicable for multimedia data that is sensitive to latency, such as Voice over Internet Protocol (VoIP) data, in a DOCSIS layer.

Currently, a Cable Modem Termination System (CMTS) and a cable modem based on DOCSIS 1.0, 1.1, and 2.0 standards are being widely used to transmit data in a cable network. However, various types of services integrating communication and broadcasting have appeared and thus a current standard has a limited service-providing capability and efficiency. In particular, in standards prior to the DOCSIS 2.0 standard, an available maximum transmission rate may be limited to about 40 Mbps for a downstream transmission, and be limited to about 30 Mbps for an upstream transmission. In order to overcome the limit of the transmission rates, channel bonding is enabled in the DOCSIS 3.0 standard so that both the CMTS and the cable modem may transmit data using a plurality of physical layers.

When transmitting upstream data in an HFC network according to a DOCSIS standard, a plurality of cable modems may temporally divide and use the same frequency band. Specifically, when a cable modem desires to transmit data in the HFC network, a CMTS may temporally divide an operating upstream bandwidth into slots and transmit MAP(bandwidth allocation map) information to the cable modem via the downstream channel. The cable modem may transmit a required amount of data in a time slot that is defined in the MAP information. Here, the MAP information indicates which time slot the cable modem may use. In the DOCSIS 3.0 standard, in the case of the upstream transmission, when a data amount that the cable modem desires to transmit is transmitted to the CMTS as a demand message, the CMTS may allocate a bandwidth with respect to upstream channels set by the cable modem during an initial registration process. In order to transmit desired data via the upstream channels, the cable modem may divide, in a form of segments, data that is stored in an interval allocated for the corresponding cable modem, using upstream channel description (UCD) information and MAP information that are transmitted to downstream channels, and thereby may transmit the divided data. When the cable modem transmits bonding data using the upstream channels, the cable modem may compare start points in times in bandwidth intervals allocated for the upstream channels, and may sequentially transmit the bonding data based on the comparison result. However, a data transmission order may be changed from an original order according to an end point in time rather than a start point in time of data transmission of each channel. Accordingly, there is a need for a process where the CMTS may sort data, transmitted in a form of segments, according to an original order to thereby restore the transmitted data in a form of DOCSIS Media Access Control (MAC) data.

### SUMMARY

According to an aspect of the present invention, there is provided an apparatus for receiving burst data in a Cable Modem Termination System (CMTS), the apparatus including: a channel bandwidth allocation unit to generate upstream bandwidth allocation information in response to an upstream bandwidth allocation query from a cable modem, and to process the generated upstream bandwidth allocation information to be transmitted to the cable modem; a burst data reception processor to receive burst data transmitted from the cable modem based on the upstream bandwidth allocation information, and to add, to the burst data, bandwidth information where the upstream bandwidth allocation information is reflected; and a segment service flow processor to sort segments in a transmission order from the cable modem, in the burst data with the added bandwidth information, and to extract a Media Access Control (MAC) frame from the sorted segments.

According to another aspect of the present invention, there is provided a method of receiving burst data in a CMTS, the method including: receiving an upstream bandwidth allocation query from a cable modem; generating and storing upstream bandwidth allocation information in response to the received upstream bandwidth allocation query; processing the stored upstream bandwidth allocation information to be transmitted to the cable modem, and to receive, from the cable modem, burst data that is based on the upstream bandwidth allocation information; adding, to the burst data, bandwidth information where the upstream bandwidth allocation information is reflected; sorting segments in a transmission order from the cable modem in the burst data with the added bandwidth information; and extracting a MAC frame from the sorted segments.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating an apparatus of receiving upstream burst data using upstream bandwidth allocation information in a Hybrid Fiber Coax (HFC) network according to an embodiment of the present invention;

FIG. 2 is a diagram for describing upstream bandwidth allocation information according to an embodiment of the present invention;

FIG. 3 is a diagram for describing a Media Access Control (MAC) frame according to an embodiment of the present invention;

FIGS. 4 through 6 illustrate an example for sorting segments with respect to four upstream channels according to an embodiment of the present invention;

FIG. 7 is a block diagram illustrating a configuration of a burst data reception processor according to an embodiment of the present invention;

FIG. 8 is a block diagram illustrating a configuration of a segment service flow processor according to an embodiment of the present invention;

FIG. 9 is a flowchart illustrating a method of receiving upstream burst data using upstream bandwidth allocation information in an HFC network according to an embodiment of the present invention;

FIG. 10 is a flowchart illustrating a method of sorting segments of burst data according to an embodiment of the present invention; and

FIG. 11 is a flowchart illustrating a method of extracting a MAC frame according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

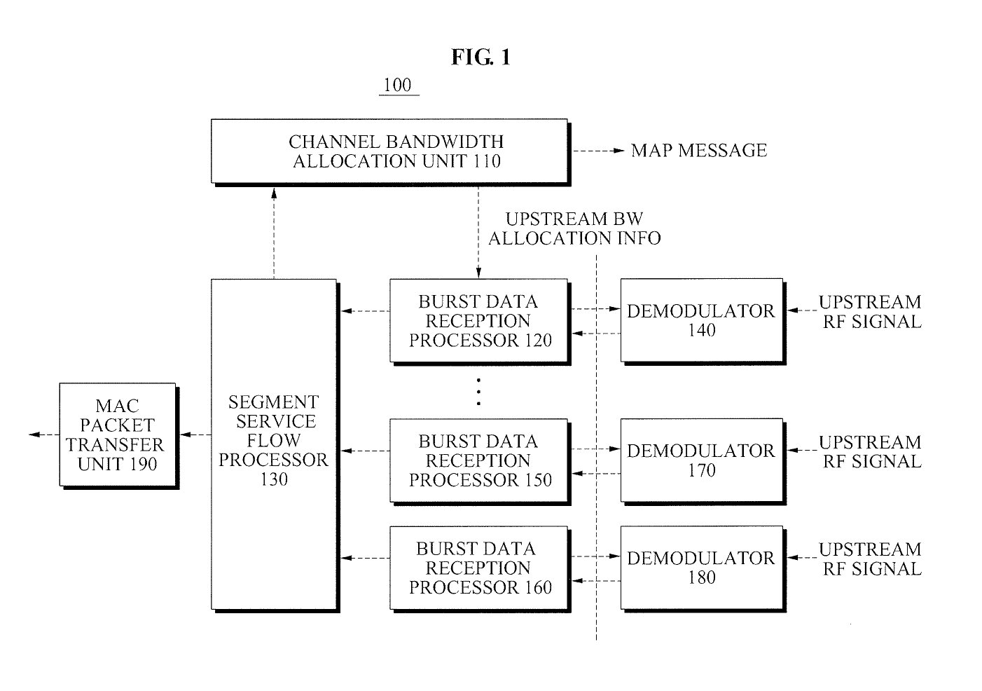

FIG. 1 is a block diagram illustrating an apparatus 100 of receiving upstream burst data using upstream bandwidth allocation information in a Hybrid Fiber Coax (HFC) network according to an embodiment of the present invention.

Although the burst data reception apparatus 100 is configured to support a maximum of four upstream channels in FIG. 1, the configuration may be further extensible depending on embodiments.

Referring to FIG. 1, the burst data reception apparatus 100 may include a channel bandwidth allocation unit 110, at least one burst data reception processor, for example, burst data reception processors 120, 150, and 160, and a segment service flow processor 130, so that a cable modem may effectively receive data transmitted via a plurality of upstream channels.

The channel bandwidth allocation unit 110 may generate upstream bandwidth allocation information in response to an upstream bandwidth allocation query from the cable modem, and may process the generated upstream bandwidth allocation information to be transmitted to the cable modem.

The burst data reception processors 120, 150, and 160 may receive burst data transmitted from the cable modem and add, to the burst data, bandwidth information where the upstream bandwidth allocation information is reflected.

The segment service flow processor 130 may sort segments in a transmission order from the cable modem, in the burst data with the added bandwidth information, and may extract a Media Access Control (MAC) frame from the sorted segments. Here, the MAC frame denotes a frame based on a Data-over-Cable Service Interface Specification (DOCSIS) 3.0 standard and may be an output of Gigabit Ethernet.

Hereinafter, an operation of the burst data reception apparatus 100 will be described in detail using the burst data reception processor 120 among the burst data reception processors 120, 150, and 160, and a demodulator 140 among demodulators 140, 170, and 180.

The demodulator 140 may receive a radio frequency (RF) signal transmitted from the cable modem, via an upstream channel bandwidth, and decode the received RF signal. The demodulator 140 may process the decoded RF signal according to a DOCSIS MAC/PHY Interface (DMPI) standard, and transfer the processed RF signal to the burst data reception processor 120.

The burst data reception processor 120 functions to process data received from the demodulator 140, and to add, into an input packet, information required to restore segments received from the upstream channels according to a transmission order, and to output the input packet. Therefore, a single burst data reception processor may be provided for each upstream channel. Here, information required for the restoration may be understood as bandwidth information where the upstream bandwidth allocation information is reflected, and may include at least one of Service Identification (SID) information associated with an allocated bandwidth among the upstream bandwidth allocation information, Interval Usage Code (IUC) information, minislot size information associated with a size of a minislot, and minislot start information associated with a start of the minislot. Specifically, the upstream bandwidth allocation information may be transferred together with basic information associated with a service flow with respect to all the intervals of which a minislot length is not zero.

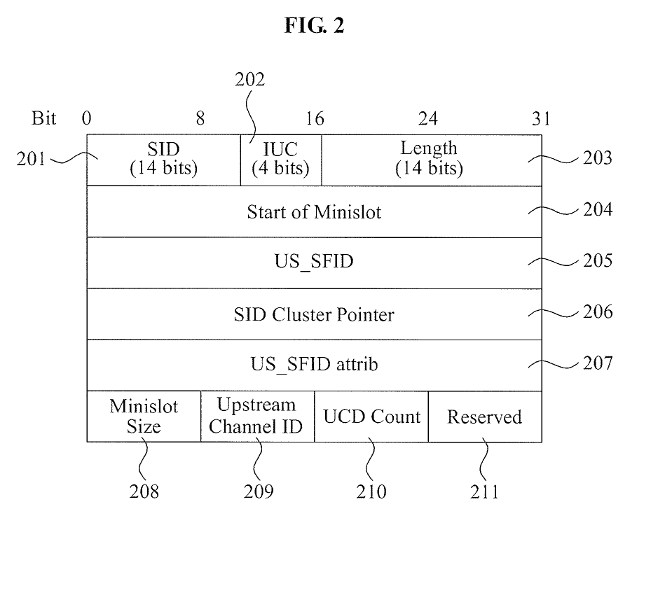

Hereinafter, the upstream bandwidth allocation information will be described in detail with reference to FIG. 2.

FIG. 2 is a diagram for describing upstream bandwidth allocation information according to an embodiment of the present invention.

As shown in FIG. 2, the upstream bandwidth allocation information may include 14 bits of SID information 201 associated with an upstream bandwidth allocated to a cable modem requesting an upstream bandwidth allocation query, 4 bits of IUC information 202, and 14 bits of length information 203 associated with a length of a minislot allocated for a particular service. Also, the upstream bandwidth allocation information may include 32 bits of information 204 associated with a start of the minislot with respect to the allocated bandwidth, information 205 associated with a service flow ID including the allocated upstream bandwidth (US_SFID), table index information 206 of a service cluster including the allocated SID (SID cluster pointer), and upstream service flow attribute information 207 for real-time processing (US_SFID attrib). For example, US_SFID attrib 207 may include information for classifying on or off of a segment, information associated with a priority of the service flow, list information of a bonded channel, and the like.

In addition, the upstream bandwidth allocation information may include minislot size information 208, upstream channel ID information 209, UCD count information 210, and a reserved space 211 for future use. Each of the information 208, 209, 210, and 211 may include 8 bits.

Specifically, according to a DOCSIS 3.0 standard, the upstream bandwidth allocation information may include basic information associated with a bandwidth allocation, for example, an SID, an IUD, a minislot size, a minislot start, and the like, with respect to the bandwidth allocation of which the minislot size is not zero in a defined MAP, and basic information associated with a service flow including a corresponding bandwidth, for example, a segment on/off, a priority, a transmission channel list, and the like. Accordingly, the burst data reception apparatus 100 may be compatible with a conventional burst data reception apparatus, whereby it is possible to decrease costs and time.

Referring again to FIG. 1, when an upstream bandwidth allocation query is received from an initial cable modem, the channel bandwidth allocation unit 110 may allocate an upstream bandwidth with respect to an upstream service flow using a segment format included in a random cable modem. In this instance, the channel bandwidth allocation unit 110 may additionally generate and store bandwidth information with the reflected upstream bandwidth allocation information, and transfer the bandwidth information to the first data reception processor 120.

The burst data reception processor 120 may process the upstream bandwidth allocation information, generated and stored by the channel bandwidth allocation unit 110, to be suitable for a DMPI standard. Also, in order to sort segments with respect to upstream channel bonding, the burst data reception processor 120 may add, to the burst data, the bandwidth information with the reflected upstream bandwidth allocation information, and output the burst data to the segment service flow processor 130.

The burst data reception processors 120, 150, and 160 may process burst data received from corresponding demodulators 140, 170, and 180. Specifically, each of the burst data reception processors 120, 150, and 160 functions to add the bandwidth information with the reflected upstream bandwidth allocation information to a block of burst data received from each channel, and transfer the burst data to the segment service flow processor 130. Accordingly, the demodulator 140 may reflect the bandwidth information in a block of burst data received using a corresponding channel, and transfer the burst data to the segment service flow processor 130.

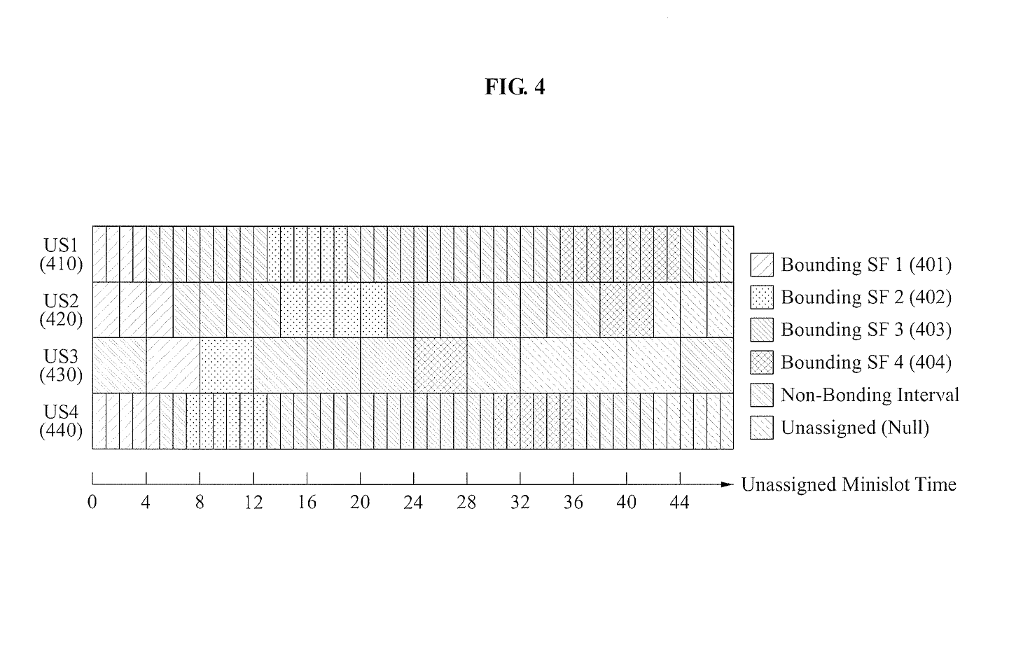

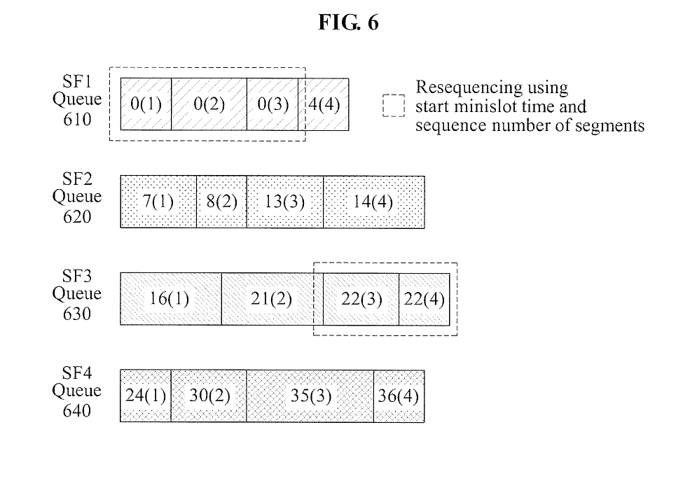

The segment service flow processor 130 may restore segments transmitted from the cable modem, using the bandwidth information added to the burst data that is received from a plurality of upstream physical layers, and a sequence number included in a segment header. Hereinafter, a process of restoring the segments using the bandwidth information and the sequence number will be described in detail with reference to FIGS. 4 through 6.

When the segments are sequentially restored, the segment service flow processor 130 may extract a DOCSIS 3.0 based MAC frame from the segments that are restored according to original orders.

The burst data reception apparatus 100 may further include a MAC packet transfer unit 190 to process a header of the extracted MAC frame to restore an Ethernet packet, and to output the restored Ethernet packet to an Ethernet interface.

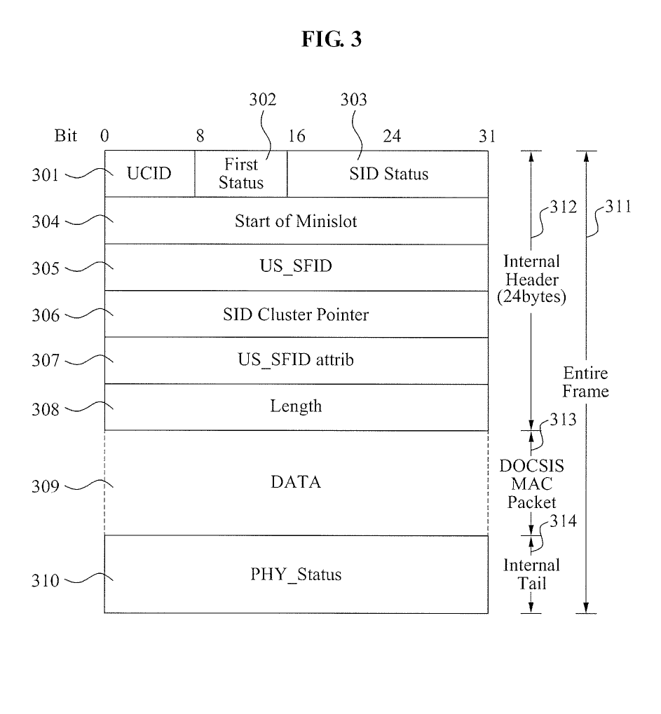

Hereinafter, the MAC frame will be described in detail with reference to FIG. 3. FIG. 3 is a diagram for describing a MAC frame 311 according to an embodiment of the present invention.

The MAC frame 311 may include data 309 configured as a DOCSIS MAC packet 313, and having internal processing information including an internal header 312 and an internal tail 314. Specifically, the burst data reception processor 120 may include, in burst data, additional information containing the internal header 312 and the internal tail 314, and output the burst data to the segment service flow processor 130. Here, the burst data may be input from the demodulator 140 according to a DMPI standard.

Here, the internal header 312 that is information for internal processing may include UCID information 301 indicating a UCID of an input packet, first status information 302, SID status information 303, minislot start information 304 associated with a start of a minislot, upstream service information (US_SFID) 305, SID cluster pointer information 306 of the input packet (SID cluster pointer), service flow attribute information (US_SFID attrib) 307 of the input packet, and length information 308 of corresponding burst data. Also, status information 310 associated with a status of a physical channel (PHY_status) may be further included.

FIGS. 4 through 6 illustrate an example for sorting segments with respect to four upstream channels according to an embodiment of the present invention.

An embodiment where the segment service flow processor 130 may determine orders of segments based on burst data received via four upstream channels will be described with reference to FIGS. 4 through 6.

Referring to FIG. 4, each of upstream channels (US1, US2, US3, and US4) 410, 420, 430, and 440 is represented as a minislot time where a bandwidth allocation status is normalized.

A MAC frame of a cable modem may be sequentially transmitted in an order of an earlier minislot start point in time among allocated bandwidths, based on MAP information of a transmittable upstream channel.

In the case of a service flow (SF1) 401, bandwidths allocated to the upstream channels (US1, US2, and US4) 410, 420, and 440 have the same start point in time and thus orders of the upstream channels (US1, US2, and US4) 410, 420, and 440 may be randomly selected by a terminal.

For example, the orders of the upstream channels (US1, US2, and US4) 410, 420, and 440 may be determined based on a sequence number included in a segment header. However, the upstream channel (US3) 430 has a last start point in time and thus may need to be transmitted last.

In the case of service flows (SF2 and SF4) 402 and 404, each of the upstream channels (US1, US2, US3, and US4) 410, 420, 430, and 440 has a different start point in time and thus a transmission order may need to be determined according to a start order of a minislot.

In the case of a service flow (SF3) 403, orders of the upstream channels (US1 and US2) 410 and 420 may be determined in the MAC frame of the cable mode. The upstream channels (US1 and US2) 410 and 420 may be classified based on their sequence numbers.

Input burst data may be transferred to the segment service flow processor 130. In the case of a transmission interval not corresponding to a segment service flow, for example, a request, ranging, a non-segment service flow packet, and the like, only an internal header may be output to the segment service flow processor 130.

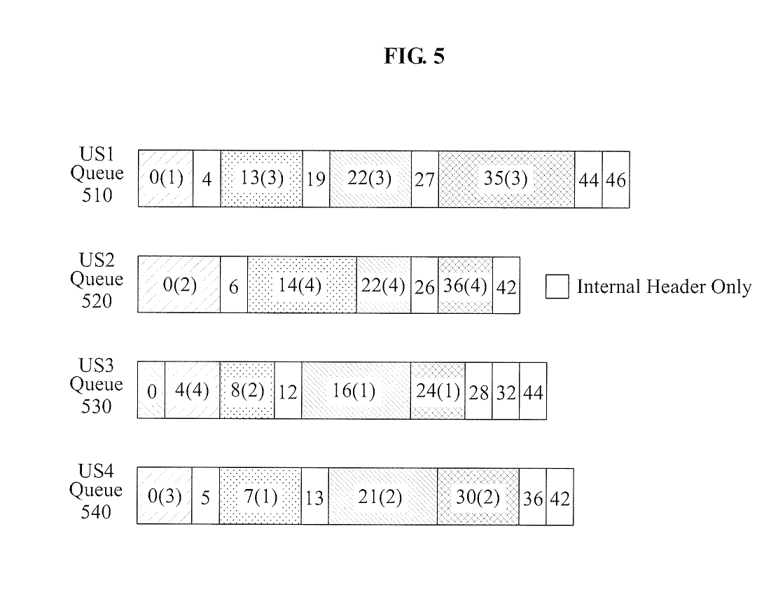

As shown in FIG. 5, packets may be stacked in a queue for each channel that is included in the segment service flow processor 130.

In FIG. 5, a number in a form of x(y) within a segment may indicate that a transmission is performed as a segment sequence number y in a normalized minislot time x.

For example, like the order of the upstream channel (1) 410, a service flow ‘0(2)’ with a start point in time 0 and a sequence number 1 is most initially stored in a queue of an upstream channel (US1) 510. At the same start point in time, a service flow ‘0(2)’ with the start point in time 0 and a sequence number 2 is most initially stored in a queue of an upstream channel (US2) 520.

According to an embodiment of the present invention, the segment service flow processor 130 may compare start points in time of service flows and sort segments based on a comparison result. When the service flows have the same start point in time, the segment service flow processor 130 may sort the segments through comparison of sequence numbers.

Upstream bandwidth allocation information and burst data with respect to packets transmitted in all the intervals of each upstream channel may exist in a queue for each channel of the segment service flow processor 130. In an interval excluding a segment service flow, only the internal header may exist.

The segment service flow processor 130 may resort the segments for each service flow using a start of a minislot included in an internal heater of each packet and a sequence number included in a segment header.

In this instance, when only internal header information exists, that is, when energy is not detected in the demodulator 140 due to a non-transmission of a terminal despite a non-segment service flow transmission interval and a segment transmission interval, the internal header information may be used only to verify start points in time of consecutive minislots. In the case of a received segment of which a data portion is lost due to a burst error when the demodulator 140 receives an RF signal, segments may need to be resorted by considering the lost data portion.

Also, from a viewpoint that a minislot unit is different for each channel, the minislot unit may need to be unified for each channel to compare starts of minislots. When a value of a minislot size defined in a transmittable upstream channel n is M(n), a normalized minislot unit may be converted according to the following Equation 1:

NCMT(n)=CMT(n)×2^{M(n)}, M(n)=0, . . . , 7 [Equation 1]

Here, CMT(n) denotes a current minislot time of the channel n, and NCMT(n) denotes a normalized minislot time.

Service flows transmitted at different points in time for each upstream channel, as shown in FIG. 4, may be sorted in queues 610, 620, 630, and 640 of service flows (SF1, SF2, SF3, and SF4) in an order where a sequence number and a start point in time of a minislot for each service flow are reflected, that is, in an original transmission order from the cable modem.

Specifically, according to an embodiment of the present invention, the burst data reception apparatus 100 may effectively restore orders of segments using a sequence number included in a segment header, defined in a DOCSIS 3.0 standard, and internal bandwidth allocation information of a CMTS.

Also, according to an embodiment of the present invention, the burst data reception apparatus 100, may restore orders of segments using only a sequence number of a segment and using internal bandwidth allocation information of a CMTS. Therefore, the burst data reception apparatus 100 may operate regardless of a bandwidth allocation algorithm, and may restore orders of segments using a simple order.

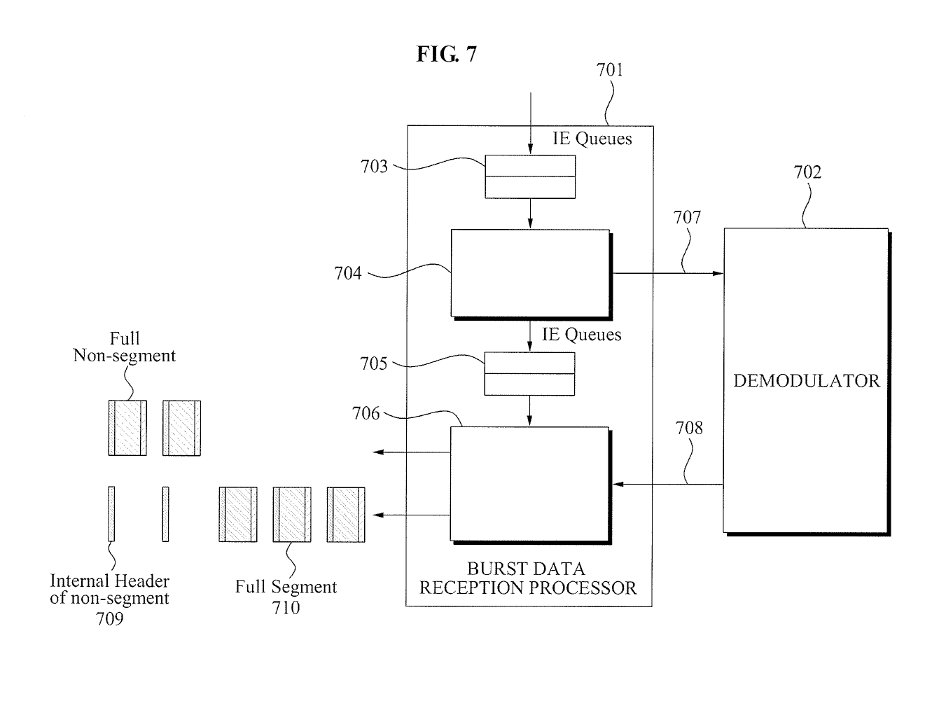

FIG. 7 is a block diagram illustrating a configuration of a burst data reception processor 701 according to an embodiment of the present invention.

The burst data reception processor 701 functions to process data received from a demodulator 702, and to add, to an input packet, information required to restore orders of segments received from each channel, and to output the input packet. The burst data reception processor 701 may include a control information processor 701 and a data reception processor 706.

The control information processor 704 functions to receive, from a channel bandwidth allocation unit (not shown), bandwidth information where upstream bandwidth allocation information is reflected. The data reception processor 706 functions to convert the received bandwidth information according to a DMPI standard.

Specifically, when a request for bandwidth information is received from the demodulator 702, the control information processor 704 may process a single bandwidth allocation information element from bandwidth allocation information element (IE) queues 703 for each channel, generate the bandwidth information, and transfer the generated bandwidth information to the demodulator 702. The bandwidth allocation information element may be stored in bandwidth allocation information element (IE) output queues 705 for each new channel.

The data reception processor 706 may interpret a block 708 of burst data input from the demodulator 702 to restore the burst data to a form of a DOCSIS MAC frame or a segment format, and transfer the restored burst data to a segment service flow processor (not shown) together with bandwidth allocation informant elements of each frame. Here, the data reception processor 706 may classify the burst data into a service flow including a segment header and a service flow excluding the segment header. An operation of the data reception processor 706 with respect to an output of the service flow including the segment header and the service flow excluding the segment header will be described later.

In the case of a service flow 709 including a segment header, the data reception processor 706 may output, to the segment service flow processor, information in a format that includes all of the bandwidth information, internal header information containing a service flow attribute, a DOCSIS-based MAC packet, PHY status information, and the like.

In the case of a service flow 710 excluding the segment header, the data reception processor 706 may output, to the segment service flow processor, information in a format that includes only the bandwidth information and internal header information including the service flow attribute.

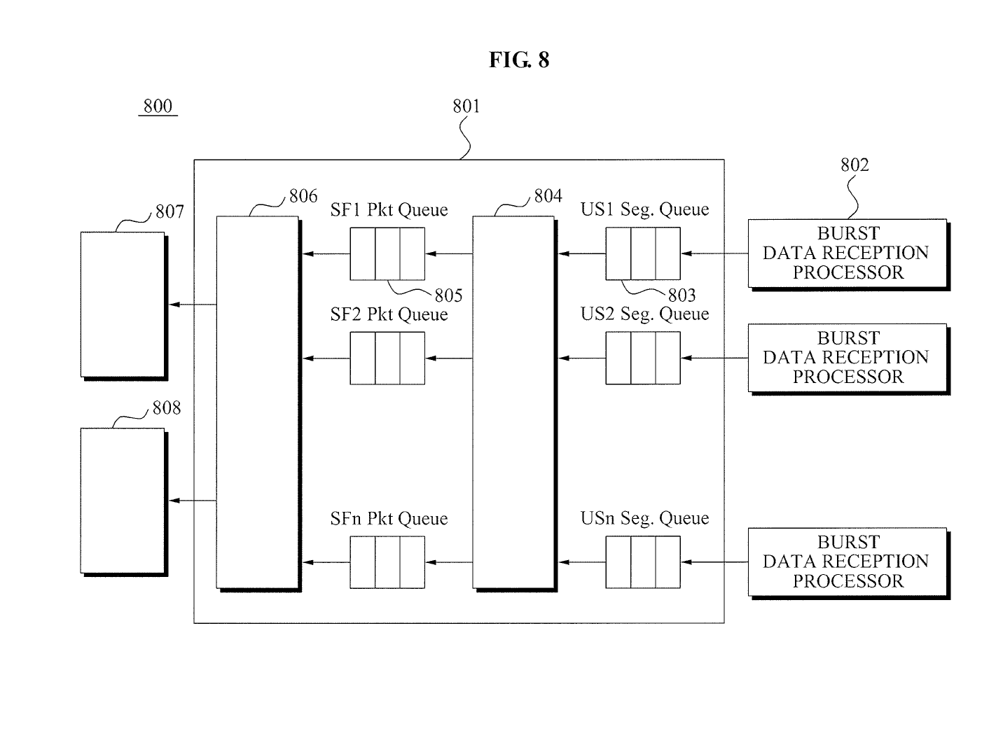

FIG. 8 is a block diagram illustrating a configuration of a segment service flow processor 800 according to an embodiment of the present invention.

The segment service flow processor 800 may sort segments in a transmission order from a cable modem in burst data with added bandwidth information, and extract a MAC frame.

For this, with respect to a data service flow in an on status of a segment header, the segment service flow processor 800 may check an error of segment header information and reassemble segments to restore data in a format of a DOCSIS MAC frame. The segment service flow processor 800 may include a segment resorting processor 804 to resort segments within a service flow including the segments, from a segment queue 803 that is input from a burst data reception processor 802, and to output the resorted segments to a service flow queue 805, and a DOCSIS frame extraction unit 806 to extract a DOCSIS-based MAC frame from the resorted segments. A packet where resorting of the segments and extracting of the DOCSIS-based MAC frame are completed may be output to a non-segment service flow processor 807. Bandwidth allocation request information included in the segment may be output to an upstream bandwidth allocation processor 808.

According to an embodiment of the present invention, the non-segment service flow processor 807 and the upstream bandwidth allocation processor 808 may be included in the MAC packet transfer unit 190 of FIG. 1.

According to an embodiment of the present invention, a burst data reception apparatus may easily sort burst data in a CMTS and thereby decrease a complexity of the burst data reception apparatus. Through this, it is possible to decrease costs for embodying the burst data reception apparatus. In addition, due to a compatibility with the conventional burst data reception apparatus, it is possible to decrease costs and time for embodying the burst data reception apparatus.

Also, according to an embodiment of the present invention, a burst data reception apparatus may readily introduce a new service that needs a high speed upstream data transmission in a cable network.

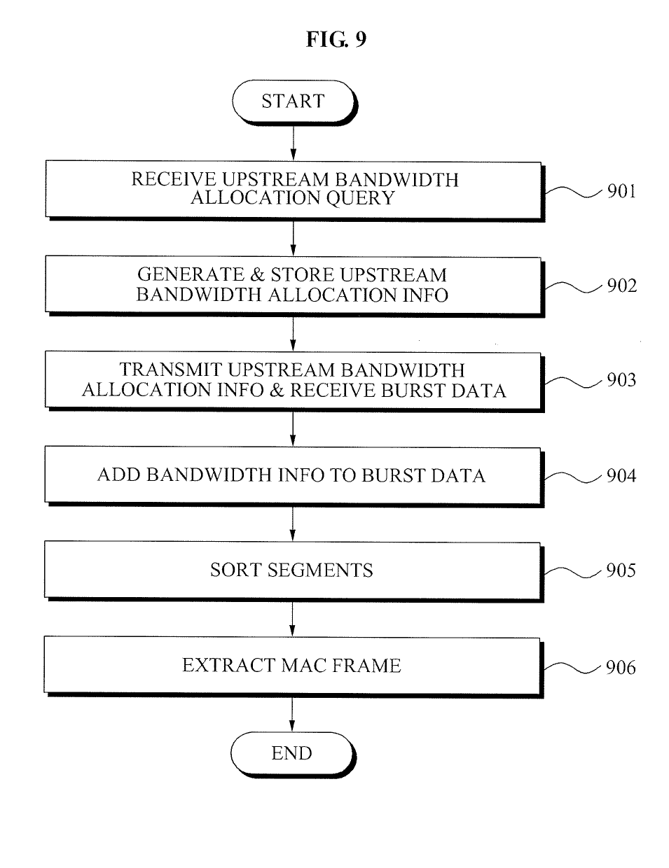

FIG. 9 is a flowchart illustrating a method of receiving upstream burst data using upstream bandwidth allocation information in an HFC network according to an embodiment of the present invention.

Referring to FIG. 9, in operation 901, a reception apparatus of a CMTS may receive an upstream bandwidth allocation query from a cable modem.

Since a plurality of cable modems temporally divides and shares a single frequency band, the CMTS may need to determine a time to allocate a predetermined bandwidth to a predetermined cable modem. Accordingly, when a request for allocating an upstream channel, that is, the upstream bandwidth allocation query is received in operation 901, the reception apparatus may generate and store upstream bandwidth allocation information in operation 902.

In operation 903, the reception apparatus may process the stored upstream bandwidth allocation information to be transmitted to the cable modem, and receive, from the cable modem, burst data that is based on the transmitted upstream bandwidth allocation information. The upstream bandwidth allocation information corresponds to information regarding that the CMTS temporally divides a slot with respect to an upstream bandwidth to thereby inform a corresponding cable modem about a time to use the upstream channel. A bandwidth may be allocated with respect to a plurality of upstream channels set by the cable modem during an initial registration process.

More specifically, instead of requiring a minislot amount according to an existing DOCSIS 2.0 standard, the cable modem may transmit a number of bytes of transmission data to the CMTS in a queue-depth request form. When the upstream bandwidth allocation query in the queue-depth request form is received, the CMTS may allocate the upstream channel with respect to a plurality of channels by considering a physical layer overhead, a MAC layer overhead, and the like with respect to amounts of data required by the cable modem. In this instance, the CMTS may enable data of the cable modem to be divided for the plurality of upstream channels set by the cable modem during the registration process and thereby be transmitted. In order to transmit desired burst data via the plurality of upstream channels, the cable modem may divide and transmit stored data into a number of segments determined by the CMTS, using UCD information and MAP information.

In operation 904, the reception apparatus may add a portion of the upstream bandwidth allocation information to the received burst data. For example, the reception apparatus may add, to the burst data, bandwidth information among the upstream bandwidth allocation information, that is, minislot start information associated with a start of a minislot. Here, the minislot corresponds to a temporally divided unit of any one segment among segments constituting the burst data. Through this, it is possible to indicate a sequence number of each of segments constituting the burst data and the minislot start information.

In operation 905, the reception apparatus may sort the segments of the burst data in a transmission order from the cable modem. In operation 906, the reception apparatus may extract a MAC frame from the sorted segments.

For example, the reception apparatus may verify at least one of the minislot start information and sequence number information included in each of the segments, and may sort the segments using the verified information. In this instance, with respect to segments having different minislot start information, the reception apparatus may sort the segments based on the minislot start information that is included in each of the segments. Also, with respect to segments having the same minislot start information, the reception apparatus may sort the segments based on the sequence number information that is included in each of the segments.

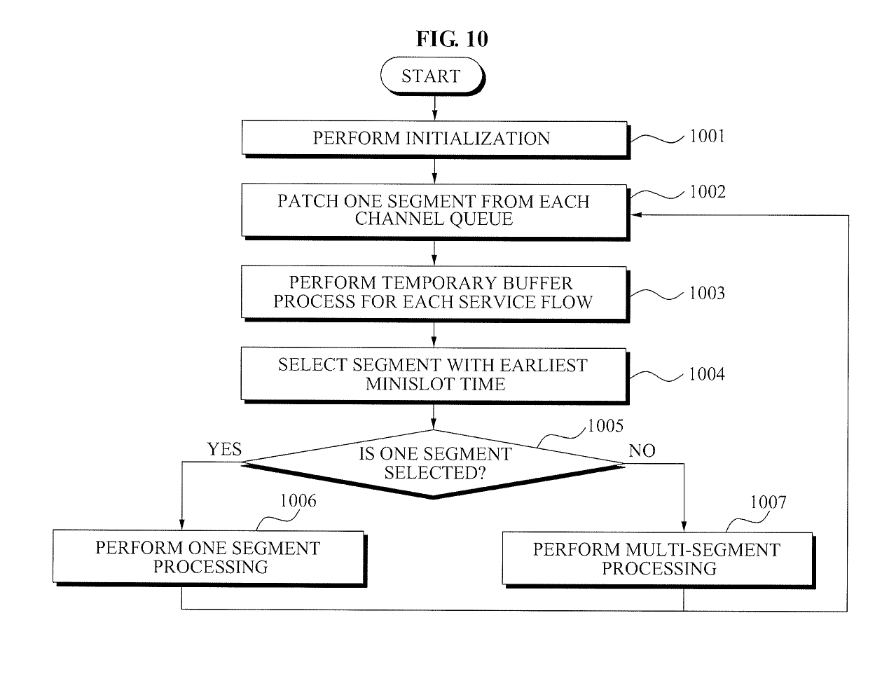

FIG. 10 is a flowchart illustrating a method of sorting segments of burst data according to an embodiment of the present invention.

Referring to FIG. 10, a process where a segment service flow processor may sort segments within a service flow including the segments, from segment queues of each channel, and output the sorted segments to each service flow queue will be described in detail with reference to FIG. 10.

In operation 1001, the segment service flow processor may perform an initialization to sort segments. During the initialization operation, the segment service flow processor may set a next sequence number NextSeq[i] to ‘0’ for each initial activated service flow, may set a start of a current minislot CurrMSlot[n] to ‘0’ for each upstream channel, and may set a start of a next minislot NextMSlot[n] to ‘0’ for each channel. Here, n and i denote a value starting from 1, and denote a number of upstream channels and a number of service flows, respectively.

In operation 1002, the segment service flow processor may take each individual segment from an input packet queue of each channel. When a packet is initially input, the segment service flow processor may set a minislot value of the input packet to CurrMSlot. Also, the segment service flow processor may verify whether a minislot start value set in an internal header of each packet is identical to a next minislot value. When they are identical to each other, the segment service flow processor may add up the current minislot start value and a minislot length to thereby apply the addition result to a next minislot start value.

When a packet does not correspond to a segment service flow, that is, when the packet is located in a request interval, a ranging interval, or non-segment service flow data transmission interval, the segment service flow processor may repeat operation 1002 until packet corresponding to a segment is read.

In operation 1003, the segment service flow processor may perform a temporary buffer process for each service flow. Specifically, when segments are stored in a temporary buffer for each service flow, the segment service flow processor may verify whether a sequence number of a segment with an earliest start point in time is identical to a next sequence number of a corresponding service flow. When they are identical to each other, the segment service flow processor may output the segment to an output segment queue of the corresponding service flow and increase the next sequence number of the corresponding service flow by one.

In operation 1004, the segment service flow processor may select a segment with an earliest minislot time. Specifically, the segment service flow processor may compare minislot time information received from each channel, and select the segment with the earliest normalized minislot time. When start points in time of multiple segments are simultaneously at the earliest minislot time, all of the segments may be selected.

In operation 1005, the segment service flow processor may verify whether a single segment is selected in operation 1004. When the single segment is selected, the segment service flow processor may perform one segment processing in operation 1006.

Specifically, the segment service flow processor may compare a next sequence number of a service flow of the selected segment and a sequence number included in the segment. When they are identical to each other, the segment service flow processor may output the selected segment to an output segment queue of the corresponding service flow, and increase the next sequence number by one. Also, when the sequence number of the segment is greater than the next sequence number, the segment service flow processor may store the segment in a temporary buffer of the corresponding service flow. When the sequence number of the segment is less than the next sequence number, the segment service flow processor may delete the segment.

As another example, when only an internal header exists and data does not exist in the selected segment, the segment service flow processor may perform as follows. Initially, the segment service flow processor may increase the next sequence number by one, depending on whether an error occurs in a corresponding segment interval due to a burst collision. Also, the segment service flow processor may indicate data loss of the corresponding segment interval in an internal header and output the segment to an output segment queue of the corresponding service flow. Also, when no transmit energy is detected, the segment service flow processor may neither change the next sequence number nor output data.

When multiple segments are selected in operation 1004, the segment service flow processor may perform multi-segment processing in operation 1007.

Specifically, the segment service flow processor may classify the selected multiple segments for each service flow ID. When a single segment corresponds to a particular service flow, the segment service flow processor may compare a next sequence number of the corresponding service flow and a sequence number included in the segment. When they are identical to each other, the segment service flow processor may output the segment to an output segment queue of the corresponding service flow and increase the next sequence number by one. Also, when the sequence number of the segment is greater than the next sequence number, the segment service flow processor may store the segment in a temporary buffer of the corresponding service flow. When the sequence number of the segment is less than the next sequence number, the segment service flow processor may delete the segment. As another example, when only an internal header exists and data does not exist in the selected segment, the segment service flow processor may increase the next sequence number by one, depending on determining whether an error occurs in a corresponding segment interval due to a burst collision. Also, the segment service flow processor may indicate data loss of the corresponding segment interval in an internal header and output the segment to an output segment queue of the corresponding service flow.

Even in this case, when no transmit energy is detected, the segment service flow processor may neither change the next sequence number nor output data.

When at least two segments exist in a particular service flow, the segment service flow processor may select a segment in an order of a lower sequence number to thereby sort the at least two segments.

Specifically, when multiple segments are stored in a temporary buffer of a corresponding service flow, the segment service flow processor may compare a next sequence number of the corresponding service flow and a sequence number of a segment with an earliest point in time among the stored segments. When they are identical to each other, the segment service flow processor may output the segment to an output segment queue of the corresponding service flow, and increase the next sequence number by one. Here, when sequence numbers of selected segments are identical to the next sequence number of the service flow, the segment service flow processor may output the selected segments to the output segment queue of the corresponding service flow. Also, when only an internal header exists and data does not exist in the selected segments, the segment service flow processor may determine whether an error occurs in a corresponding segment interval due to a burst collision. Depending on the decision result, the segment service flow processor may indicate data loss of the corresponding segment interval in an internal header, and output the segment to an output segment queue of the corresponding service flow.

Even in this case, when no transmit energy is detected, the segment service flow processor may neither change the next sequence number nor output data.

When the sequence numbers of the selected segments are greater than the next sequence number of the corresponding service flow, the segment service flow processor may store the segments in a temporary buffer of the corresponding service flow. In this instance, with respect to a segment interval where only the internal header exists and data does not exist among the selected segments, the segment service flow processor may determine whether an error occurs in the segment interval due to a burst collision, and thereby may indicate a data loss of the segment interval in an internal header and store the segment in a temporary buffer of the corresponding service flow. Also, when the sequence numbers of the selected segments are less than the next sequence number, the segment service flow processor may delete the segments.

When all the selected segments are output to channels, respectively, the segment service flow processor may select and read new segments from each of channels including the selected segments, and perform temporary buffer processing for each service flow in operation 1003.

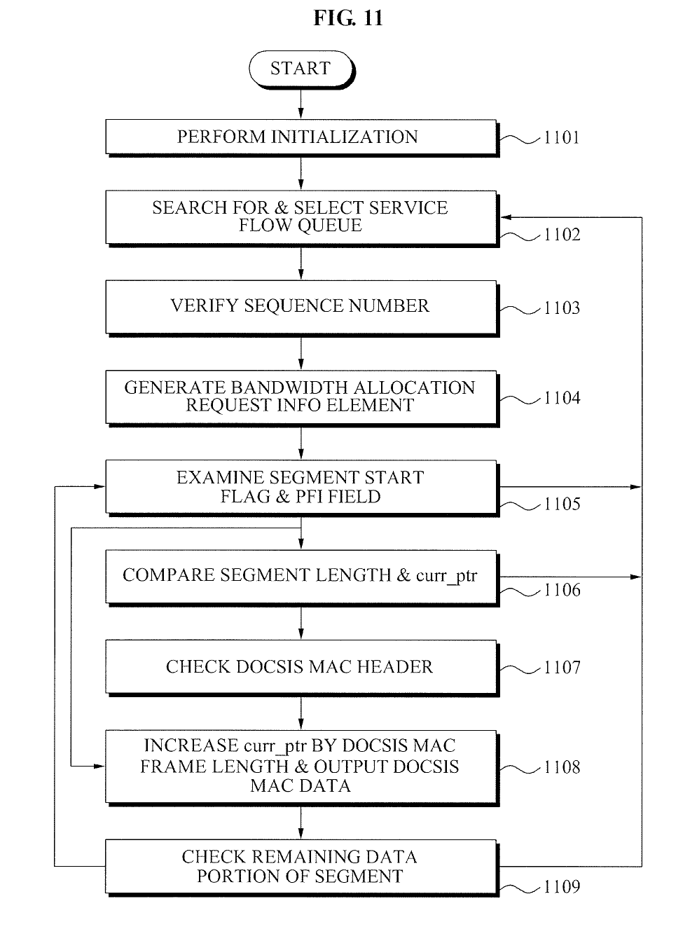

FIG. 11 is a flowchart illustrating a method of extracting, by a segment service flow processor, a MAC frame according to an embodiment of the present invention.

In operation 1101, the segment service flow processor may perform an initialization. Specifically, during the initialization operation, the segment service flow processor may set a segment start flag to ‘1’ for each service flow, and set a next sequence number to ‘0’ for each service flow.

In operation 1102, the segment service flow processor may search for and select a service flow queue including a segment. Here, the segment service flow processor may search for service flow queues. When a segment exists in a flow segment queue, the segment service flow processor may select a corresponding service flow queue and take one segment from the corresponding service flow queue.

In operation 1103, the segment service flow processor may check a sequence number of the segment. Specifically, when a next sequence number of the selected service flow is different from a sequence number included in a segment header, the segment service flow processor may set the start flag to ‘1’. When remaining previous data of the selected segment service flow exists, the segment service flow processor may delete the remaining data. Also, the segment service flow processor may set the next sequence number of the selected segment service flow to the sequence number within the segment header.

When a request field value of a segment is not ‘0’, the segment service flow processor may generate and output bandwidth allocation request information elements to an upstream bandwidth allocation processing block in operation 1104. In operation 1105, the segment service flow processor may examine a segment start flag and a Packet Flow Identifier (PFI) field. Here, when the segment start flag is ‘1’ and the PFI field is ‘0’, it indicates a ‘start’ and no DOCSIS MAC boundary exists. Therefore, the segment service flow processor may delete the corresponding segment and continue to operation 1102.

Also, when the segment start flag is ‘0’ and the PFI field is ‘0’, it indicates a consecutive portion and no DOCSIS MAC boundary exists. The segment service flow processor may store remaining data by adding the entire segment data to data stored in a buffer, and continue to operation 1102.

Also, when the segment start flag is ‘1’ and the PFI field is ‘1’, it indicates a start but a DOCSIS MAC boundary exists. In this case, the segment service flow processor may set the segment start flag to ‘0’ and set a current pointer value curr_ptr to a point field value, and continue to operation 1106.

Also, when the segment start flag is ‘0’ and the PFI field is ‘1’, it indicates a consecutive portion and a DOCSIS MAC boundary exists. In this case, the segment service flow processor may set the current pointer value curr_ptr to the point file value, combine data stored in the remaining data buffer, and segment data up to before the current pointer value curr_ptr, and thereby determine whether a DOCSIS MAC frame header integrity and a DOCSIS MAC frame length are the same as a value set in the segment header. When the DOCSIS MAC frame header and the DOCSIS MAC frame length are normal, the segment service flow processor may continue to operation 1108

In operation 1106, the segment service flow processor may compare a segment length and the current pointer value curr_ptr within the segment.

When the current pointer value curr_ptr is the same as the segment length, the segment service flow processor may set the segment start flag to ‘1’, and continue to operation 1102. Also, when a difference between the segment length and the current pointer value curr_ptr is less than the DOCSIS MAC frame header length, the segment service flow processor may store, in the remaining data buffer, data from the current pointer value curr_ptr to a segment end, and continue to operation 1102. Also, when the difference between the segment length and the current pointer value curr_ptr is greater than or equal to the DOCSIS MAC frame header length, the segment service flow processor may continue to operation 1107.

In operation 1107, the segment service flow processor may check the DOCSIS MAC frame header at a designated location.

Specifically, to check the DOCSIS MAC frame header, the segment service flow processor may extract the DOCSCIS MAC frame header and a frame size, and perform an error check in the extracted DOCSIS MAC frame header.

In operation 1108, the segment service flow processor may increase the current pointer value curr_ptr by the extracted DOCSIS MAC frame length, and output extracted DOCSIS MAC data.

When the DOCSIS MAC data is output, the segment service flow processor may check a remaining data portion of the segment in a corresponding queue in operation 1109. For example, when no remaining data exists in the segment, the segment service flow processor may set the segment start flag to ‘1’ and continue to operation 1102. When remaining data exists in the segment, the segment service flow processor may verify whether a first byte of the remaining data is 0xFF. Depending on the verification result, the segment flow processor may discard all the remaining data and then set the segment start flag to ‘1’, and continue to operation 1102. When the first byte is not 0xFF, the segment service flow processor may continue to operation 1106.

According to an embodiment of the present invention, the segment service flow processor operated as above may effectively receive data that is transmitted from a cable modem to a CMTS via a plurality of upstream channels, based on an upstream channel transmission form defined in a DOCSIS 3.0 standard. Also, a burst data reception apparatus according to an embodiment of the present invention may readily introduce a new service that needs a high speed upstream data transmission in a cable network.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

According to an embodiment of the present invention, a CMTS may effectively receive data that is transmitted in an upstream channel bonding form defined in a DOCSIS 3.0 standard.

Also, according to an embodiment of the present invention, it is possible to decrease a complexity of a reception apparatus by simply sorting orders of burst data based on upstream bandwidth allocation information.

Also, according to an embodiment of the present invention, it is possible to decrease costs for embodying a reception apparatus by simply sorting orders of burst data based on upstream bandwidth allocation information.

Also, according to an embodiment of the present invention, it is possible to decrease costs and time for embodying a reception apparatus through a compatibility with a conventional reception apparatus.

Also, according to an embodiment of the present invention, it is possible to easily introduce a new service that needs a high speed upstream data transmission in a cable network.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for receiving burst data in a Cable Modem Termination System (CMTS), the apparatus comprising:
a channel bandwidth allocation unit to generate upstream bandwidth allocation information in response to an upstream bandwidth allocation query from a cable modem, and to process the generated upstream bandwidth allocation information to be transmitted to the cable modem;
a burst data reception processor to receive burst data transmitted from the cable modem based on the upstream bandwidth allocation information, and to add, to the burst data, bandwidth information where the upstream bandwidth allocation information is reflected; and
a segment service flow processor to sort segments in a transmission order from the cable modem, in the burst data with the added bandwidth information, and to extract a Media Access Control (MAC) frame from the sorted segments.

2. The apparatus of claim 1, wherein the burst data reception processor comprises:
a control information processor to receive, from the channel bandwidth allocation unit, the bandwidth information where the upstream bandwidth allocation information is reflected, and to convert the bandwidth information according to a Data-over-Cable Service Interface Specifications (DOCSIS) MAC/PHY (DMPI) standard; and
a data reception processor to add the converted bandwidth information to the burst data.

3. The apparatus of claim 2, wherein the data reception processor classifies a first service flow including a segment header and a second service excluding the segment header, in the burst data with the added bandwidth information.

4. The apparatus of claim 3, wherein the data reception processor transfers, to the segment service flow processor, at least one of the bandwidth information, internal header information containing an attribute of the first service flow, a MAC packet, and reception status information, with respect to the first service flow including the segment header.

5. The apparatus of claim 3, wherein the data reception processor transfers, to the segment service flow processor, the upstream bandwidth allocation information and internal header information containing an attribute of the second service flow, with respect to the second service flow excluding the segment header.

6. The apparatus of claim 1, wherein the MAC frame generated by the segment service flow processor is based on a DOCSIS 3.0 standard.

7. The apparatus of claim 1, wherein the upstream bandwidth allocation information generated in response to the upstream bandwidth allocation query includes at least one of Service Identification (SID) information associated with an allocated bandwidth, Interval Usage Code (IUC) information, minislot size information associated with a size of a minislot, and minislot start information associated with a start of the minislot.

8. The apparatus of claim 7, wherein the bandwidth information includes the minislot start information.

9. The apparatus of claim 1, wherein the segment service flow processor comprises:
a segment resorting processor to resort the segments within a service flow of the segments; and
a DOCSIS frame extraction unit to extract a DOCSIS-based MAC frame from the resorted segments.

10. The apparatus of claim 1, further comprising:
a demodulator to demodulate the burst data transmitted from the cable modem, and to transfer the demodulated burst data to the burst data reception processor.

11. The apparatus of claim 1, further comprising:
a MAC packet transfer unit to process a header of the extracted MAC frame to restore an Ethernet packet, and to output the restored Ethernet packet to an Ethernet interface.

12. A method of receiving burst data in a CMTS, the method comprising:
receiving an upstream bandwidth allocation query from a cable modem;
generating and storing upstream bandwidth allocation information in response to the received upstream bandwidth allocation query;
processing the stored upstream bandwidth allocation information to be transmitted to the cable modem, and to receive, from the cable modem, burst data that is based on the upstream bandwidth allocation information;
adding, to the burst data, bandwidth information where the upstream bandwidth allocation information is reflected;
sorting segments in a transmission order from the cable modem in the burst data with the added bandwidth information; and
extracting a MAC frame from the sorted segments.

13. The method of claim 12, wherein the bandwidth information includes minislot start information associated with a start of a minislot, and the minislot corresponds to a temporally divided unit of any one segment among the segments.

14. The method of claim 12, wherein the sorting comprises:
verifying at least one of sequence number information and minislot start information that are included in each of the segments; and
sorting the segments based on the verified at least one information.

15. The method of claim 13, wherein the sorting comprises:
with respect to segments having different minislot start information, sorting the segments based on the minislot start information that is included in each of the segments; and
with respect to segments having the same minislot start information, sorting the segments based on sequence number information that is included in each of the segments.
